(19) United States
(12) Patent Application Publication
(10) Pub. No.: US 2018/0127536 A1
(43) Pub. Date: May 10, 2018

(54) MIXTURES OF POLYETHER CARBONATE POLYOLS AND POLYETHER POLYOLS FOR PRODUCING POLYURETHANE SOFT FOAMS

(71) Applicant: Covestro Deutschland AG, Leverkusen (DE)

(72) Inventors: Stefan Lindner, Remscheid (DE); Norbert Hahn, Rommerskirchen (DE); Angelika Schulz, Leverkusen (DE)

(21) Appl. No.: 15/569,001

(22) PCT Filed: Apr. 28, 2016
(86) PCT No.: PCT/EP2016/059470

§ 371 Date: Oct. 24, 2017

(30) Foreign Application Priority Data
Apr. 29, 2015 (EP) 15165791.3

(51) Int. Cl. C08G 18/44; C08G 18/48; C08G 18/76

(52) U.S. Cl. CPC C08G 18/44; C08G 18/4816; C08G 2101/0008; C08G 18/7621; C08G 18/4837

(57) ABSTRACT

The present invention relates to a process for producing flexible polyurethane foam materials, in particular hot-moulded foams, by reaction of an isocyanate component with a component reactive to isocyanates, wherein the constituents of the component reactive to isocyanates include a polyether polyol and a polyether carbonate polyol. The invention further relates to flexible polyurethane foams produced by the process according to the invention.

### CROSS-REFERENCE TO RELATED APPLICATIONS

This Application is a National Phase Application of PCT/EP2016/059470, filed Apr. 28, 2016, which claims priority to European Application No. 15165791.3, filed Apr. 29, 2015, each of which is being incorporated herein by reference.

### FIELD

The present invention relates to a process for producing flexible polyurethane foam materials, in particular hot-moulded foams, by reaction of an isocyanate component with a component reactive to isocyanates, wherein the constituents of the component reactive to isocyanates include a polyether polyol and a polyether carbonate polyol. The invention further relates to flexible polyurethane foams produced by the process according to the invention.

### BACKGROUND

WO-A 2008/058913, WO-A 2012/163944, WO-A 2014/072336, WO 2014/074706, as well as the as yet unpublished application bearing application number EP 13194565.1, describe the production of flexible polyurethane foams from polyether carbonate polyols mixed with polyether polyols.

WO-A 2012/055221 describes the production of a polyether carbonate polyol-based polyisocyanate prepolymer which is foamed to a flexible foam with a polyether.

As part of the environmentally friendly alignment of production processes, it is generally desirable to use relatively large amounts of CO₂-based source materials. The object of the present invention is to make available a process for producing flexible polyurethane foams, in particular hot-moulded foams, which have a high proportion of polyether carbonate polyols, wherein the foams display greater hardness and, in particular, higher tensile strength at the same bulk density as comparable foams of prior art.

### SUMMARY

Surprisingly this object was achieved by a process for producing flexible polyurethane foams in which the isocyanate-reactive compound comprised a mixture of ≥10 to ≤90% by weight of a polyether carbonate polyol and ≤90 to ≥10% by weight of a special polyether polyol.

The subject matter of the invention is therefore a process for producing flexible polyurethane foams by reaction of an isocyanate component with a component reactive to isocyanates, wherein the component reactive to isocyanates comprises the following constituents:
A) ≥10 to ≤90% by weight, preferably ≥20 to ≤80% by weight, particularly preferably ≥30 to ≤70% by weight of a polyether carbonate polyol with a hydroxyl number conforming to DIN 53240 of ≥20 mg KOH/g to ≤250 mg KOH/g obtainable by copolymerisation of
   ≥2% by weight to ≤30% by weight carbon dioxide and ≥70% by weight to ≤98% by weight of one or more alkylene oxides
   in the presence of one or more H-functional starter molecules with an average functionality of ≥1 to ≤6, preferably of ≥1 and ≤4, particularly preferably ≥2 and ≤3,
B) ≤90 to ≥10% by weight, preferably ≤80 to ≥20% by weight, particularly preferably ≤70 to ≥30% by weight of a polyether polyol with a hydroxyl number conforming to DIN 53240 of ≥20 mg KOH/g to ≤250 mg KOH/g, a fraction of primary OH groups of ≥20 to ≤80 mol %, preferably ≥30 to ≤60 mol % with reference to the total number of primary and secondary OH groups and a fraction of ethylene oxide of 5 to 30% by weight, preferably 10 to 20% by weight with reference to the total amount of propylene oxide and ethylene oxide,
   wherein the polyether polyol is free from carbonate units and is obtainable
   by catalytic addition of ethylene oxide and propylene oxide and possibly of one or more further alkylene oxides to one or more H-functional starter compounds with a functionality of ≥2 to ≤6, preferably ≥3 to ≤4,
C) ≥0 to ≤45% by weight, preferably ≥5 to ≤35% by weight, particularly preferably ≥10 to ≤30% by weight of one or more polymer polyols, PHD polyols and/or PIPA polyols,
with the total quantity from A), B) and C) giving 100% by weight.

It was found that when using such polyether carbonate polyol/polyether mixtures, which are identified by the special combination of the content of ethylene oxide and primary OH groups in the polyether, it is possible to produce flexible polyurethane foams which have a comparable bulk density and at the same time greater hardness and in particular a significantly higher tensile strength by comparison with foams of prior art.

The use of a polyether carbonate polyol/polyether mixtures with such a special polyether is not disclosed in any of the above-listed documents of prior art.

A further subject matter of the invention are flexible polyurethane foams produced in accordance with the process according to the invention.

The production of the flexible polyurethane foams, preferably flexible hot-moulded polyurethane foams, takes place in accordance with known methods.

The components described in more detail below may be used for the production of the flexible polyurethane foams.

### DETAILED DESCRIPTION

Component A) comprises a polyether carbonate polyol with a hydroxyl number (OH number) conforming to DIN 53240 of ≥20 mg KOH/g to ≤250 mg KOH/g, preferably of 20 mg KOH/g to ≤150 mg KOH/g, particularly preferably of ≥25 mg KOH/g to ≤90 mg KOH/g, which is obtainable by copolymerisation of ≥22% by weight to ≤30% by weight carbon dioxide and ≥70% by weight to ≤98% by weight with one or more alkylene oxides, in the presence of one or more H-functional starter molecules with an average functionality of ≥1 to ≤6, preferably of ≥1 and ≤4, particularly preferably ≥2 and ≤3, with the polyether carbonate polyol having no terminal alkylene oxide blocks. For the purposes of the invention “H-functional” is taken to mean a starter compound which has active H atoms in respect of alkoxylation.

The copolymerisation of carbon dioxide and one or more alkylene oxides preferably takes place in the presence of at least one DMC catalyst (double metal cyanide catalyst).

The polyether carbonate polyols used according to the invention preferably also have ether groups between the carbonate groups, as schematically represented in formula (VIII). In the diagram according to formula (VIII) R stands for an organic residue such as alkyl, alkyl aryl or aryl, each of which may also contain heteroatoms such as, for example O, S, Si etc, e and f stand for an integer. The polyether carbonate polyol shown in the diagram according to formula (VIII) should simply be understood in the sense that blocks with the structure shown can in principal be found in the polyether carbonate polyol, but the sequence, number and length of the blocks can vary and are not restricted to the polyether carbonate polyol shown in formula (VIII). With reference to formula (VIII) this means that the ratio of e/f is preferably 2:1 to 1:20, particularly preferably 1.5:1 to 1:10.

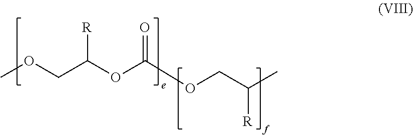

In a preferred embodiment of the invention the polyether carbonate polyol A) has a carbonate group content (“units originating from carbon dioxide”), calculated as CO₂, of ≥2.0 and ≤30.0% by weight, preferably of ≥5.0 and ≤28.0% by weight and particularly preferably of 10.0 and ≤25.0% by weight.

The proportion of incorporated CO₂ (“units originating from carbon dioxide”) in a polyether carbonate polyol can be determined from the evaluation of characteristic signals in the ¹H-NMR spectrum. The example below illustrates the determination of the fraction of units originating from carbon dioxide in a CO₂/propylene oxide-polyether carbonate polyol started on 1.8 octanediol.

The proportion of incorporated CO₂ in a polyether carbonate polyol as well as the ratio of propylene carbonate to polyether carbonate polyol can be determined by means of ¹H-NMR (a suitable device is made by Bruker, DPX 400, 400 MHz; pulse program zg30, hold time dl: 10 s, 64 scans). Each sample is dissolved in deuterated chloroform. The relevant resonances in the ¹H-NMR (with reference to TMS=0 ppm) are as follows:

cyclic carbonate (formed as a by-product) with resonance at 4.5 ppm; carbonate, resulting from carbon dioxide incorporated in the polyether carbonate polyol with resonances at 5.1 to 4.8 ppm; incompletely reacted propylene oxide (PO) with resonance at 2.4 ppm; polyether polyol (i.e. without incorporated carbon dioxide) with resonances at 1.2 to 1.0 ppm; the 1.8 octanediol incorporated as starter molecule (where present) with a resonance at 1.6 to 1.52 ppm.

The mole content of the carbonate incorporated in the polymer in the reaction mixture is calculated as follows according to formula (I), with the following abbreviations being used:

F(4.5)=surface of resonance at 4.5 ppm for cyclic carbonate (corresponds to an H atom)

F(5.1-4.8)=surface of resonance at 5.1-4.8 ppm for polyether carbonate polyol and an H atom for cyclic carbonate.

F(2.4)=surface of resonance at 2.4 ppm for free, incompletely reacted PO

F(1.2-1.0)=surface of resonance at 1.2-1.0 ppm for polyether polyol

F(1.6-1.52)=surface of resonance at 1.6 to 1.52 ppm for 1.8 octanediol (starter), where present

Bearing in mind the relative intensities, the conversion to mol % was carried out according to the following formula (I) for the polymer-bound carbonate (“linear carbonate” LC) in the reaction mixture:

$$L C = \frac{F ( 5 , 1 - 4 , 8 ) - F ( 4 , 5 )}{\begin{matrix}F ( 5 , 1 - 4 , 8 ) + F ( 2 , 4 ) + 0 , 33 * \\ F ( 1 , 2 - 1 , 0 ) + 0 , 25 * F ( 1 , 6 - 1 , 52 )\end{matrix}} * 100 \qquad ( I )$$

The proportion by weight (in % by weight) of polymer-bound carbonate (LC′) in the reaction mixture was calculated according to formula (II),

$$L {C}^{′} = \frac{[ F ( 5 , 1 - 4 , 8 ) - F ( 4 , 5 ) ] * 102}{N} * 100 \% \qquad ( II )$$

the value for N (“denominator” N) being calculated according to formula (III):

N=[F(5,1−4,8)−F(4,5)]*102+F(4,5)*102+F(2,4)*58+0,33*F(1,2−1,0)*58+0,25*F(1,6−1,52)*146 (III)

The factor 102 results from the sum of the molecular weights of CO₂ (molecular weight 44 g/mol) and that of propylene oxide (molecular weight 58 g/mol), the factor 58 results from the molecular weight of propylene oxide and the factor 146 from the molecular weight of the 1.8 octanediol starter used (where present).

The proportion by weight (in % by weight) of cyclic carbonate (CC′) in the reaction mixture was calculated according to formula (IV),

$$C {C}^{′} = \frac{F ( 4 , 5 ) * 102}{N} * 100 \% \qquad ( IV )$$

the value for N being calculated according to formula (III).

In order to calculate from the values of the composition of the reaction mixture the composition with reference to the polymer fraction (comprising polyether polyol, which was formed from starter and propylene oxide during the activation steps taking place under CO₂-free conditions, and polyether carbonate polyol, formed from starter, propylene oxide and carbon dioxide during the activation steps taking place in the presence of CO₂ and during copolymerisation), the non-polymer constituents of the reaction mixture (i.e. cyclic propylene carbonate as well as any unconverted propylene oxide present) were eliminated by calculation. The proportion by weight of the carbonate repeating units in the polyether carbonate polyol was converted into a carbon dioxide fraction by weight by means of the factor F=44/(44+58). The information on the CO₂ content in the polyether carbonate polyol is standardised to the fraction of the polyether carbonate polyol molecule formed during copolymerisation and, if applicable, the activation steps in the presence of CO₂ (i.e. not taken into consideration here was the fraction of the polyether carbonate polyol molecule resulting from the starter (1.8 octanediol, where present) as well as from the reaction of the starter with epoxy which was added under CO₂-free conditions).

By way of example, the production of polyether carbonate polyols involves a process according to A), in which:
(α) an H-functional starter substance or a mixture of at least two H-functional starter substances are provided, and possibly water and/or other highly volatile compounds are removed at elevated temperature and/or reduced pressure (“drying”), with the DMC catalyst being added to the H-functional starter substance or to the mixture of at least two H-functional starter substances before or after drying,
(β) for activation a part quantity of one or more alkylene oxides (with reference to the total quantity of the amount of alkylene oxides used during activation and copolymerisation) is added to the mixture resulting from step (α), with said addition of a part quantity of alkylene oxide possibly taking place in the presence of CO₂ and with the temperature spike (“hot spot”) occurring due to the ensuing exothermic chemical reaction and/or a pressure drop in the reactor then being awaited in each case, and with step (β) for activation possibly also occurring several times,
(γ) one or more of the alkylene oxides and carbon dioxide are added to the mixture resulting from step (β), with the alkylene oxides used in step (γ) possibly being identical to or different from the alkylene oxides used in step (β), and with no further alkyloxylation step following step (γ).

In general alkylene oxides (epoxides) with 2 to 24 carbon atoms can be used to produce polyether carbonate polyols. The alkylene oxides with 2 to 24 carbon atoms are, for example, one or more compounds selected from the group comprising ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, single or multiple epoxidised fats as mono-, di- and triglycerides, epoxidised fatty acids, C₁-C₂₄ esters of epoxidised fatty acids, epichlorhydrin, glycidol, and glycidol derivatives such as methyl glycidyl ether, ethyl glycidyl ether, 2-ethylhexyl glycidyl ether, allyl glycidyl ether, glycidyl methacrylate as well as epoxy functional alkoxysilanes such as 3-glycidyloxypropyltrimethoxysilane, 3-glycidyloxypropyltriethoxysilane, 3-glycidyloxypropyltripropoxysilane, 3-glycidyloxypropyl-methyl-dimethoxysilane, 3-glycidyloxypropylethyldiethoxysilane, 3-glycidyloxypropyltrlisopropoxysilane. Preferably ethylene oxide and/or propylene oxide and/or 1,2 butylene oxide are used as alkylene oxides, particularly preferably propylene oxide.

In a preferred embodiment of the invention the fraction of ethylene oxide in the amount of propylene oxide and ethylene oxide used in total is ≥0 and ≤90% by weight, preferably ≥0 and ≤50% by weight, and particularly preferably free from ethylene oxide.

Compounds with active H atoms for alkoxylation may be used as suitable H-functional start substances. Examples of active groups with active H atoms for alkoxylation are

—OH, —NH₂ (primary amines), —NH— (secondary amines), —SH and —CO₂H, —OH and —NH₂ are preferred, —OH is particularly preferred. By way of example, one or more compounds selected from the following group is used as an H-functional starter substance: water, mono- or polyvalent alcohols, polyvalent amines, polyvalent thiols, amino alcohols, thioalcohols, hydroxyesters, polyether polyols, polyester polyols, polyester ether polyols, polyether carbonate polyols, polycarbonate polyols, polycarbonates, polyethyleneimines, polyether amines (e.g. so-called Jeffamine® from Huntsman, such as D-230, D-400, D-2000, T-403, T-3000, T-5000 or corresponding BASF products such as polyether amine D230, D400, D200, T403, T5000), polytetrahydrofurane (e.g. PolyTHF® from BASF, examples being PolyTHF® 250, 650S, 1000, 1000S, 1400, 1800, 2000), polytetrahydrofuranamine (BASF product Polytetrahydrofuranamine 1700), polyether thiols, polyacrylate polyols, castor oil, the mono- or diglyceride of ricinoleic acid, monoglycerides of fatty acids, chemically modified mono-, di- and/or triglycerides of fatty acids, and C₁-C₂₄ alkyl-fatty acid esters which on average contain at least 2 OH-groups per molecule. Examples of C₁-C₂₄ alkyl-fatty acid esters which on average contain at least 2 OH-groups per molecule are commercial products like Lupranol Balance® (BASF AG), Merginol® types (Hobum Oleochemicals GmbH), Sovermol® types (Cognis Deutschland GmbH & Co. KG) and Soyol®TM types (USSC Co.).

Alcohols, amines, thiols and carbonic acids may be used as monofunctional starter compounds. The following may find use as monofunctional alcohols: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridin, 3-hydroxypyridin, 4-hydroxypyridin. Possible monofunctional amines are: butylamine, tert-butylamine, pentylamine, hexylamine, aniline, aziridine, pyrrolidine, piperidine, morpholine. The following may be used as monofunctional thiols: ethanethiol, 1-propanethiol, 2-propanethiol, 1-butanethiol, 3-methyl-1-butanethiol, 2-butene-1-thiol, thiophenol. The following are monofunctional carbonic acids: formic acid, acetic acid, propionic acid, butyric acid, fatty acids such as stearic acid, palmitic acid, oleic acid, linoleic acid, linolenic acid, benzoic acid, acrylic acid.

Examples of suitable polyvalent alcohols as H-functional starter substances are bivalent alcohols (such as ethylene glycol, diethylene glycol, propylene glycol, dipropylene glycol, 1,3-propanediol, 1,4-butanediol, 1,4-butenediol, 1,4-butynediol, neopentyl glycol, 1,5-pentanediol, methylpentanediols (such as, for example, 3-methyl-1,5-pentanediol), 1,6-hexanediol; 1,8-octanediol, 1,10-decanediol, 1,12-dodecanediol, bis-(hydroxymethyl)-cyclohexanes (such as 1,4-bis-(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trivalent alcohols (such as trimethylolpropane, glycerin, trishydroxyethylisocyanurate, castor oil); quadrivalent alcohols (such as pentaerythrite); polyalcohols (such as sorbitol, hexite, sucrose, starch, starch hydrolysates, cellulose, cellulose hydrolysates, hydroxy-functionalised fats and oils, in particular castor oil), as well as all the modification products of these aforementioned alcohols with differing amounts of ε-caprolactone. In mixtures of H-functional starters trivalent alcohols such as trimethylolpropane, glycerin, trishydroxyethylisocyanurate and castor oil may also be used.

The H-functional starter substances may also be selected from the polyether polyol class of substances, in particular those with a molecular weight Mₙ in the region of 100 to 4000 g/mol, preferably 250 to 2000 g/mol. Preference is given to polyether polyols formed from repeating ethylene oxide and propylene oxide units, preferably in a proportion of 35 to 100% propylene oxide units, particularly preferably in a proportion of 50 to 100% propylene oxide units. These may be statistical copolymers, gradient copolymers, alternating or block copolymers from ethylene oxide and propylene oxide. Examples of suitable polyether polyols formed from repeating propylene oxide and/or ethylene oxide units are Desmophen®-, Acclaim®-, Arcol®-, Baycoll®-, Bayfill®-, Bayflex®-Baygal®-, PET®- and polyether polyols made by Bayer MaterialScience AG (e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Examples of other suitable homo-polyethylene oxides are the Pluriol® E brands from BASF SE, examples of suitable homo-propylene oxides are the Pluriol® P brands from BASF SE, examples of suitable mixed copolymers from ethylene oxide and propylene oxide are the Pluronic® PE or Pluriol® RPE brands from BASF SE.

The H-functional starter substances may also be selected from the polyester polyol class of substances, in particular those with a molecular weight Mₙ in the region of 200 to 4500 g/mol, preferably 400 to 2500 g/mol. At least difunctional polyesters are used as polyester polyols. Polyester polyols from alternating acid and alcohol units are preferred. Examples of acid components used are succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures from aforementioned acids and/or anhydrides. Examples of alcohol components used are ethanediol, 1,2-propanediol, 1,3-propanediol, 1,4-butanediol, 1,5-pentanediol, neopentylglycol, 1,6-hexanediol, 1,4-Bis-(hydroxymethyl)-cyclohexane, diethylene glycol, dipropylene glycol, trimethylolpropane, glycerin, pentaerythrite or mixtures from the aforementioned alcohols. The polyester ether polyols obtained if bivalent or polyvalent polyether polyols are used as alcohol components may also serve as starter substances for producing polyether carbonate polyols. If polyether polyols are used for producing polyester ether polyols, polyether polyols with a number average molecular weight Mₙ of 150 to 2000 g/mol are preferred.

Polycarbonate polyols may also be used as H-functional starter substances (for example polycarbonate diols), particularly those with a molecular weight Mₙ in the region of 150 to 4500 g/mol, preferably 500 to 2500, produced, for example by conversion of phosgene, dimethyl carbonate, diethyl carbonate or diphenyl carbonate and di- and/or polyfunctional alcohols or polyester polyols or polyether polyols. Examples of polycarbonate polyols can be found, for example, in EP-A 1359177. By way of example, the Desmophen® C types from Bayer MaterialScience AG, such as Desmophen® C 1100 or Desmophen® C 2200 may be used.

Polyether carbonate polyols may also be used as H-functional starter substances. In particular use is made of polyether carbonate polyols produced according to the process described above. For this these polyether carbonate polyols used as H-functional starter substances are produced in a previous separate reaction step.

Preferred H-functional starter substances are alcohols of the general formula (V),

HO—(CH₂)ₓ—OH (V)

where x is a number from 1 to 20, preferably an even number from 2 to 20. Examples of alcohols according to formula (V) are ethylene glycol, 1,4-butanediol, 1,6-hexanediol, 1,8-octanediol, 1,10 decanediol and 1,12-dodecanediol. Other preferred H-functional starter substances are neopentyl glycol, trimethylolpropane, glycerin, pentaerythrite, conversion products of alcohols according to formula (I) with e-caprolactone, e.g. conversion products of trimethylolpropane with e-caprolactone, conversion products of glycerin with e-caprolactone, as well as conversion products of pentaerythrite with e-caprolactone. Also preferred for use as H-functional starter substances are water, diethylene glycol, dipropylene glycol, castor oil, sorbitol and polyether polyols, formed from repeating polyalkylene oxide units.

Particularly preferred H-functional starter substances are one or more compounds selected from the group comprising ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, diethylene glycol, dipropylene glycol, glycerin, trimethylolpropane, di- and trifunctional polyether polyols, with the polyether polyol being formed from a di- or tri-H-functional starter substance and propylene oxide or a di- or tri-H-functional starter substance, propylene oxide and ethylene oxide. The polyether polyols preferably have a number average molecular weight Mₙ in the region of 62 to 4500 g/mol and in particular a number average molecular weight Mₙ in the region of 62 to 3000 g/mol, very particularly preferably a molecular weight of 62 to 1500 g/mol. The polyether polyols preferably have a functionality of ≥2 to ≤3.

In a preferred embodiment of the invention the polyether carbonate polyol is obtainable by attachment of carbon dioxide and alkylene oxides to H-functional starter substances using multi-metal cyanide catalysts (DMC catalysts). The production of polyether carbonate polyols by attachment of alkylene oxides and CO₂ to H-functional starters using DMC catalysts is known, for example, from EP-A 0222453, WO-A 2008/013731 and EP-A 2115032.

DMC catalysts are known in principle from prior art for the homopolymerisation of epoxides (see e.g. U.S. Pat. No. 3,404,109, U.S. Pat. No. 3,829,505, U.S. Pat. No. 3,941,849 and U.S. Pat. No. 5,158,922). DMC catalysts as, for example, described in U.S. Pat. No. 5,470,813, EP-A 700 949, EP-A 743 093, EP-A 761 708, WO-A 97/40086, WO-A 98/16310 and WO-A 00/47649, show very high activity in the homopolymerisation of epoxides and allow the production of polyether polyols and/or polyether carbonate polyols at very low catalyst concentrations (25 ppm or less). A typical example are the highly active DMC catalysts described in EP-A 700 949, which in addition to a double metal cyanide compound (e.g. zinc hexacyanocobaltate(III)) and an organic complex ligand (e.g. tert.-butanol) still contain a polyether with a number average molecular weight Mₙ greater than 500 g/mol.

The DMC catalyst is generally used in an amount of ≤1% by weight, preferably in an amount of ≤0.5% by weight, particularly preferably in an amount of ≤500 ppm and in particular in an amount of ≤300 ppm, in each case with reference to the weight of the polyether carbonate polyol.

Component B) comprises polyether polyols with a hydroxyl number conforming to DIN 53240 of ≥20 mg KOH/g to ≤250 mg KOH/g, preferably of ≥20 to ≤112 mg KOH/g and particularly preferably ≥20 mg KOH/g to ≤80 mg KOH/g, a fraction of primary OH groups of ≥20 to ≤80 mol %, preferably ≥30 to ≤60 mol % with reference to the total number of primary and secondary OH groups and a fraction of ethylene oxide of 5 to 30% by weight, preferably 10 to 20% by weight with reference to the total amount of propylene oxide and ethylene oxide and is free from carbonate units. The production of the compounds according to B) may take place by catalytic addition of ethylene oxide and propylene oxide and possibly of one or more further alkylene oxides to one or more H-functional starter compounds.

As further alkylene oxides (epoxides) alkylene oxides with 2 to 24 carbon atoms may be used. Examples of alkylene oxides with 2 to 24 carbon atoms are one or more compounds selected from the group comprising ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, single or multiple epoxidised fats as mono-, di- and triglycerides, epoxidised fatty acids, C₁-C₂₄ esters of epoxidised fatty acids, epichlorhydrin, glycidol, and glycidol derivatives such as methyl glycidyl ether, ethyl glycidyl ether, 2-ethylhexyl glycidyl ether, allyl glycidyl ether, glycidyl methacrylate as well as epoxy functional alkoxysilanes such as 3-glycidyloxypropyltrimethoxysilane, 3-glycidyloxypropyltriethoxysilane, 3-glycidyloxypropyltripropoxysilane, 3-glycidyloxypropyl-methyl-dimethoxysilane, 3-glycidyloxypropylethyldiethoxysilane, 3-glycidyloxypropyltrlisopropoxysilane. 1,2 butylene oxide is preferably used as a further alkylene oxide.

The alkylene oxides may be introduced to the reaction mixture separately, as a mixture, or consecutively. They may be statistical or block copolymers. If the alkylene oxides are dosed consecutively, the products produced (polyether polyols) contain polyether chains of block structure.

The H-functional starter compounds have functionalities of ≥2 to ≤6, preferably ≥3 to ≤4 and are preferably hydroxy-functional (OH-functional). Examples of hydroxy-functional starter compounds are propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerin, trimethylolpropane, triethanolamine, pentaerythrite, sorbitol, sucrose, hydroquinone, catechol, resorcinol, bisphenol F, bisphenol A, 1,3,5-trihydroxybenzene, methylol group-containing condensates from formaldehyde and phenol or melamine or urea. 1,2-propylene glycol and/or glycerin and/or trimethylolpropane and/or sorbitol is preferred for use as a starter compound.

Component C includes polymer polyols, PUD-polyols and PIPA-polyols. Polymer polyols are polyols which contain fractions of solid polymers produced by radical polymerisation of suitable monomers such as styrene or acrylonitrile in a basic polyol. PUD (polyurea dispersion) polyols are, for example, produced by in situ polymerisation of an isocyanate or an isocyanate mixture with a diamine and/or hydrazine in a polyol, preferably a polyether polyol. The PUD dispersion is preferably produced by conversion of an isocyanate mixture applied from a mixture of 75 to 85% by weight 2,4-toluene diisocyanate (2,4-TDI) and 15 to 25% by weight 2,6-toluene diisocyanate (2,6-TDI) with a diamine and/or hydrazine in a polyether polyol, preferably a polyether polyol produced by alkoxylation of a trifunctional starter (such as glycerin and/or trimethylolpropane, for example). Process for producing Verfahren PUD dispersions are, for example, described in U.S. Pat. No. 4,089,835 and U.S. Pat. No. 4,260,530. The PIPA polyols are polyether polyols alkanolamine-modified by polyisocyanate-polyaddition, with the polyether polyol having a functionality of 2.5 to 4 and a hydroxyl number of ≥3 mg KOH/g to ≤112 mg KOH/g (molecular weight 500 to 18000). PIPA polyols are described in detail in GB 2 072 204 A, DE 31 03 757 A1 and U.S. Pat. No. 4,374,209 A.

Suitable isocyanate components include the technically easily accessible polyisocyanates, for example 2,4- and 2,6-toluene diisocyanate, as well as any mixtures of these isomers (“TDI”); polyphenyl polymethylene polyisocyanate, as produced by aniline-formaldehyde condensation and subsequent phosgenation (“raw MDI”) and polyisocyanates having carbodiimide groups, urethane groups, allophanate groups, isocyanurate groups, urea groups or biuret groups (“modified polyisocyanates”), in particular those modified polyisocyanates derived from 2,4- and/or 2,6-toluene diisocyanate and from 4,4′- and/or 2,4′-diphenyl methane diisocyanate. The polyisocyanate used is preferably at least one compound from the group comprising 2,4- and 2,6-toluene diisocyanate, 4,4′- and 2,4′- and 2,2′-diphenyl methane diisocyanate and polyphenyl polymethylene polyisocyanate (“Multicore MDI”).

Of course standard additives such as stabilising agents, catalysts, etc. can also continue to be used in producing the flexible polyurethane foam.

Further aspects and embodiments of the present invention are described below. They can be combined as required, unless the context explicitly indicates the contrary.

In one embodiment of the process according to the invention, in the component reactive to isocyanates the total fraction of units originating from carbon dioxide in the polyols present amounts to ≥2.0% by weight to ≤30.0% by weight, with reference to the total weight of the polyols present. This proportion amounts to preferably ≥5.0% by weight to ≤25.0% by weight, particularly preferably ≥8.0% by weight to ≤20.0% by weight.

To produce the flexible polyurethane foams the reaction components are converted by the single-stage process itself known in the art, with mechanical devices often being used, e.g. such as those described in EP-A 355 000. Details of processing facilities which also come into question according to the invention are described in the Kunststoff-Handbuch, Band VII [Plastics Manual, Vol. VII], issued by Vieweg and Hochtlen, Carl-Hanser-Verlag, Mtinchen 1993, e.g. on pages 139 to 265.

The flexible polyurethane foams may be produced as moulded foams, e.g. hot-moulded foams. The subject matter of the invention is therefore a process for producing flexible polyurethane foams, the flexible polyurethane foams produced according to this process, the flexible moulded polyurethane foams produced according to this process, the flexible hot-moulded polyurethane foams produced according to this process, the use of the flexible polyurethane foams for producing moulded parts as well as the moulded parts themselves. The following are examples of applications for the flexible polyurethane foams obtainable according to the invention: Furnishing upholstery, textile inserts, mattresses, car seats, headrests, armrests, sponges, foam sheets for use in car parts such as roof liners, door trim panels, seat cushions and structural elements. The flexible polyurethane foams preferably find application as car seats.

During the production of moulded foams by the hot-moulding process the mould is first prepared with a separating agent and possibly inserts such as composite flock foam or wire are introduced. The reaction mass is then put into the mould. Dosing and mixing can by carried out by high pressure or low pressure machines. The raw materials are normally processed within the range of 15° C. to 50° C., preferably between 18 and 30° C. and particularly preferably between 20° C. and 24° C. The temperature of the mould is normally between 20° C. and 60° C., preferably between 25° C. and 50° C. and particularly preferably between 30° C. and 40° C. The filled mould is closed with a cover which has outlet drill holes, and is transferred to a tempering oven. The necessary outlet drill holes are numerous and allow excess foam to escape. Work can therefore be carried out at almost no pressure and the mould covers are only weakly dimensioned. The foam is tempered in the oven. The oven heats the mould to an inside wall temperature of 60° C. to 250° C., preferably 100 to 140° C. After a final reaction time of, for example, 10 to 15 minutes, the mould is opened and the moulded foam can be removed. The mould is cooled down again and the process can restart. The industrial production of hot-moulded foams normally takes place in a cycle.

In another embodiment of the process according to the invention the flexible polyurethane foam has a compression hardness (40% compression) conforming to DIN EN ISO 1798 of ≥0.8 kPa to ≤12.0 kPa, preferably ≥2.0 kPa to ≤8.0 kPa.

In a further embodiment of the process according to the invention the index is ≥85 to ≤125. The index is preferably within a range of ≥90 to ≤120. The index indicates the percentage ratio of the quantity of isocyanate actually used to the stoichiometric quantity, i.e. the quantity of isocyanate group (NCO) quantity calculated for the conversion of the OH-equivalents.

Index=[isocyanate quantity used):(isocyanate quantity calculated)*100 (VI)

In a further embodiment of the process according to the invention the reaction of the isocyanate component with the isocyanate-reactive component takes place in the presence of one or more catalysts. The catalysts used may be aliphatic tertiary amines (for example trimethylamine, triethylamine, tetramethylbutanediamine), cycloaliphatic tertiary amines (for example 1,4-diaza(2,2,2)bicyclooctane), aliphatic amino ethers (for example dimethylaminoethyl ether and N,N,N-trimethyl-N-hydroxyethyl-bisaminoethyl ether), cycloaliphatic amino ethers (for example N-ethylmorpholine), aliphatic amidines, cycloaliphatic amidines, urea, urea derivatives (such as aminoalkyl ureas, see for example EP-A 0 176 013, in particular (3-dimethylaminopropylamine)-urea) and tin catalysts (such as dibutyltin oxide, dibutyltin dilaurate, tin(II)-ethylhexanoate, tin ricinoleate).

In a further embodiment of the process according to the invention the reaction takes place in the presence of water as a propellant. Other physical or chemical propellants such as liquid carbon dioxide or dichloromethane may possibly be present.

In a further embodiment of the process according to the invention the isocyanate component comprises at least one compound selected from the group 2,4-, 2,6-toluene diisocyanate (TDI), 4,4′-, 2,4′-, 2,2′-diphenylmethane diisocyanate and polyphenyl polymethylene polyisocyanate (“multicore MDI”). A toluene diisocyanate mixture of isomers from 80% by weight 2,4- and 20% by weight 2,6-TDI is preferred.

In a further embodiment of the process according to the invention the polyether carbonate polyol(s) according to A) have a hydroxyl number of ≥20 mg KOH/g to ≤250 mg KOH/g and are obtainable by copolymerisation of ≥2.0% by weight to ≤30.0% by weight of carbon dioxide and ≥70% by weight to ≤98% by weight of propylene oxide in the presence of a hydroxy-functional starter molecule such as trimethylolpropane and/or glycerin and/or propylene glycol and/or sorbitol. The hydroxyl number can be determined in accordance with DIN 53240.

In a further embodiment of the process according to the invention the polyol(s) according to B) have a hydroxyl number of ≥20 mg KOH/g to ≤80 mg KOH/g and a primary OH group content of ≥20 to ≤80 mol % with reference to the total number of primary and secondary OH-groups and are obtainable by copolymerisation of ≥5% by weight to ≤30% by weight ethylene oxide and ≥70% by weight to ≤95% by weight of propylene oxide in the presence of a hydroxy-functional starter molecule such as trimethylolpropane and/or glycerin and/or propylene glycol and/or sorbitol. The hydroxyl number can be determined in accordance with DIN 53240.

In a further embodiment the invention relates to a process according to one of the above embodiments, wherein the polyether carbonate polyol(s) A) have blocks according to formula (VIII) with an e/f ratio of 2:1 to 1:20.

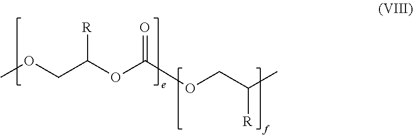

The present invention further relates to a flexible polyurethane foam which is obtainable by means of the process according to the invention. The bulk density thereof conforming to DIN EN ISO 3386-1-98 can be in the range of ≥10 kg/m³ to ≤150 kg/m³, preferably in the range of ≥15 kg/m³ to ≤60 kg/m³.

### Examples

The present invention will now be explained further with the aid of the following examples, but without being limited thereto. In the examples: Polyol A signifies: polyether polyol with an OH number of 56 mg KOH/g, produced in the presence of KOH as catalyst by the addition of propylene oxide and ethylene oxide using glycerin as a starter. The polyether polyol has an ethylene oxide end block, 45 mol % primary OH-groups and contains 83% propylene oxide and 13% ethylene oxide.

Polyol B: polyether polyol with an OH number of 56 mg KOH/g, produced in the presence of KOH as catalyst by the addition of propylene oxide using glycerin as a starter.

Polyol C: trifunctional polyether carbonate polyol based on glycerin with hydroxyl number 57 mg KOH/g, obtained by copolymerisation of 20% by weight carbon dioxide with 80% by weight propylene oxide.

Polyol D: Arcol® Polyol HS 100 (polymer polyol Bayer MaterialScience) is an inactive polyether polyol with a styrene acrylonitrile (SAN) polymer with a solids content of approx. 45% by weight and an OH number of approx. 28 mg KOH/g.

B4900: Tegostab® B4900 is a silicon stabiliser for hot-moulded foam made by Evonik

Niax A1: Niax® catalyst A-1 is an amine catalyst made by Momentive

SO: Dabco® T-9 (tin-II-octanoate) is a catalyst from Air Products

T80: Desmodur T80 is a product of Bayer MaterialScience AG and is made from 2,4- and 2,6-diisocyanate toluene.

Bulk density was determined in accordance with DIN EN ISO 845.

Compression hardness was determined in accordance with DIN EN ISO 3386-1 (at 40% deformation and 4th cycle).

Tensile strength and elongation at break were determined in accordance with DIN EN ISO 1798.

Compression set was determined in accordance with DIN EN ISO 1856.

The hydroxyl number was determined in accordance with DIN 53240.

Determination of the proportion of primary OH groups: by means of ¹H-NMR (Bruker DPX 400, deuterochloroform):

To determine the primary OH group content the polyol samples were first peracetylated.

The following peracetylation mix was prepared:
9.4 g acetic anhydride p.A.
1.6 g acetic acid p.A.
100 ml pyridine p.A.

For the peracetylation reaction 10 g polyol (polyether carbonate polyol or polyether polyol) were weighed into a 300 ml ground glass-stoppered Erlenmeyer flask. The volume of peracetylation mixture depended on the OH number of the polyol to be peracetylated, with (in each case with reference to 10 g Polyol) the OH number of the polyol being rounded up to the nearest 10th place; 10 ml of peracetylation mixture were then added per 10 mg KOH/g. For example, 50 ml of peracetylation mixture were accordingly added to the 10 g sample of a polyol with an OH number=45.1 mg KOH/g.

After the addition of glass boiling granules the ground Erlenmeyer flask was provided with a riser tube (air cooler) and the sample was boiled for 75 min under weak reflux. The sample mixture was then transferred to a 500 ml round-bottomed flask, and volatile constituents (essentially pyridine, acetic acid and excess acetic anhydride) were distilled off for a period of 30 min at 80° C. and 10 mbar (absolute). The distillation residue was then mixed three times with 100 ml of cyclohexane (alternatively toluene was used in cases where the distillation residue was insoluble in cyclohexane) and in each case volatile constituents were removed for 15 min at 80° C. and 400 mbar (absolute). Volatile constituents of the sample were then removed for one hour at 100° C. and 10 mbar (absolute).

To determine the molar fraction of primary and secondary OH end groups in the polyol, the sample thus prepared was dissolved in deuterated chloroform and examined by means of ¹H-NMR (Bruker, DPX 400, 400 MHz, pulse program zg30, hold time dl: 10 s, 64 scans). The relevant resonances in the ¹H-NMR (with reference to TMS=0 ppm) were as follows:

Methyl signal of a peracetylated secondary OH end group: 2.04 ppm

Methyl signal of a peracetylated primary OH end group: 2.07 ppm

The molar fraction of the secondary and primary OH end groups was then shown as follows:

Fraction of secondary OH end groups (CH—OH)=F(2.04)/(F(2.04)+F(2.07))*100% (X)

Fraction of primary OH end groups (CH2-OH)=F(2.07)/(F(2.04)+F(2.07))*100% (XI)

In the formulae (X) and (XI) F stands for surface of resonance at 2.04 ppm and 2.07 ppm respectively.

Production of Polyurethane Flexible Moulded Foams

In the usual processing method for producing polyurethane flexible moulded foam materials by the hot-moulded foam processing the single-stage method the input materials listed in the examples in the following table are reacted together. The reaction mixture is put into a metallic mould heated to 40° C. and first coated with a separating agent (Gorapur LH724-3), covered with a lid which has numerous ventilation drill holes, and then put into a drying cupboard at 140° C. for 15 minutes. The quantity of the raw materials used is selected so that the mould is evenly filled.

TABLE 1

| | | Comparative | Example | Example | Comparative | Comparative | Example | Example |
|---|---|---|---|---|---|---|---|---|
| POLYOL | Unit | example 1 | 2 | 3 | example 4 | example 5 | 6 | 7 |
| Polyol A | Tle. | 100 | 50 | 25 | | | 35 | 50 |
| Water | Tle. | 3.5 | 3.5 | 3.5 | 3.5 | 3.5 | 3.5 | 3.5 |
| B4900 | Tle. | 1.0 | 1.5 | 2.0 | 1.5 | 1.5 | 1.0 | 1.0 |
| Polyol C | Tle. | 0 | 50 | 75 | 50 | 75 | 35 | 50 |
| Polyol B | | | | | 50 | 75 | | |
| Polyol D | | | | | | | 30 | |
| Niax A1 | Tle. | 0.15 | 0.15 | 0.15 | 0.15 | 0.15 | 0.15 | 0.15 |
| SO | Tle. | 0.10 | 0.14 | 0.14 | 0.20 | 0.20 | 0.14 | 0.1 |
| Isocyanate | | | | | | | | |
| T80 | Tle. | 42.5 | 42.5 | 42.5 | 42.6 | 42.7 | 41.30 | 42.5 |
| PROCESSING | | | | | | | | |
| Index | | 100 | 100 | 100 | 100 | 100 | 100 | 100 |
| CO2 fraction % | | | 7 | 10 | 7 | 10 | 5 | 7 |
| by weight in the | | | | | | | | |
| foam | | | | | | | | |
| TEST RESULTS | | | | | | | | |
| Bulk density | kg/m³ | 30.9 | 29.7 | 28.8 | 28.34 | 27.43 | 30.15 | — |
| Compressive | kPa | 3.44 | 3.53 | 2.92 | 3.51 | 3.18 | 5.18 | — |
| strength CLD | | | | | | | | |
| 4/40 | | | | | | | | |
| Tensile strength | kPa | 105 | 119 | 123 | 97 | 85 | 126 | — |
| Elongation at | % | 166 | 179 | 189 | 194 | 155 | 156 | — |
| break | | | | | | | | |
| Compression set | % (ct) | 2.3 | 2.6 | 2.9 | 4.1 | 4.5 | 2.7 | — |
| 50%/22 h/70° C. | | | | | | | | |
| Compression set | % (ct) | 2.6 | 3.1 | 5 | 7.9 | 8.8 | 5.2 | — |
| 75%/22 h/70° C. | | | | | | | | |

Examples 2 and 3 according to the invention, which contain the polyether carbonate polyol and a polyether polyol containing EO, have comparable bulk densities, better tensile strength and elongation at break than comparative example 1, which contains no polyether carbonate polyol. As opposed to comparative examples 4 and 5, which contain the polyether carbonate polyol in combination with a pure polyether containing PO, examples 2 and 3 according to the invention show considerably better values relative to tensile strength and compression set with comparative bulk density.

The quantity of catalyst and stabiliser was adjusted to obtain comparable foams without obvious defects (e.g. severe settling, cracking). Thus the quantity of catalyst and stabiliser from comparative example 1 with the polyol composition from example 2 resulted in a vertical crack through the foam. The experiment is described in Example 7. Due to the crack it was not possible to determine any mechanical characteristics.

1. A process for producing flexible polyurethane foams comprising reacting an isocyanate component with a component reactive with isocyanates, wherein the component reactive with isocyanates comprises:
A) ≥10 to ≤90% by weight of a polyether carbonate polyol with a hydroxyl number conforming to DIN 53240 of ≥20 mg KOH/g to ≤250 mg KOH/g, which is obtainable by copolymerisation of
≥2% by weight to ≤30% by weight carbon dioxide and ≥70% by weight to ≤98% by weight of one or more alkylene oxides
in the presence of one or more H-functional starter molecules with an average functionality of ≥1 to ≤6,
B) ≤90 to ≥10% by weight of a polyether polyol with a hydroxyl number conforming to DIN 53240 of ≥20 mg KOH/g to ≤250 mg KOH/g, a fraction of primary OH groups of ≥20 to ≤80 mol %, based on 100 mol % of the total number of primary and secondary OH groups, and a fraction of ethylene oxide of 5 to 30% by weight, based on 100% by weight of propylene oxide and ethylene oxide,
wherein the polyether polyol is free from carbonate units and is obtainable
by catalytic addition of ethylene oxide and propylene oxide and optionally one or more other alkylene oxides to one or more H-functional starter compounds with a functionality of ≥2 to ≤6,
C) ≥0 to ≤45% by weight of one or more polymer polyols, PHD polyols and/or PIPA polyols,
wherein the sum of the quantity of A), B) and C) totals 100% by weight.

2. The process according to claim 1, wherein said alkylene oxide in component A) comprises at least one of ethylene oxide, propylene oxide and 1,2 butylene oxide.

3. The process according to claim 1, wherein said polyether carbonate polyol has a hydroxyl number of ≥20 mg KOH/g to ≤150 mg KOH/g.

4. The process according to claim 1, wherein said polyether polyol in component B has a fraction of primary OH groups of ≥30 to ≤60 mol %, based on 100 mol % of primary and secondary OH groups.

5. The process according to claim 1, wherein said polyether polyol in component B has a fraction of ethylene oxide of 10 to 20% by weight, based on 100% by weight of propylene oxide and ethylene oxide.

6. The process according to claim 1, wherein the polyether polyol in component B contains no other alkylene oxides apart from ethylene oxide and propylene oxide.

7. The process according to claim 1, wherein the polyether polyol in component B has a hydroxyl number of ≥20 mg KOH/g to ≤112 mg KOH/g.

8. The process according to claim 1, wherein said component reactive with isocyanates comprises ≥20 to ≤80% by weight of A) and ≤80 to ≥20% by weight of B).

9. The process according to claim 1, wherein said component reactive with to isocyanates comprises ≥30 to ≤70 of A) and ≤70 to ≥30% by weight of B).

10. The process according to claim 1, wherein said component reactive with isocyanates comprises ≥5 to ≤35% by weight of C).

11. The process according to claim 1, wherein the isocyanate component comprises 2,4-, 2,6-toluene diisocyanate (TDI), 4,4′-, 2,4′-, 2,2′-diphenylmethane diisocyanate (MDI) and/or polyphenylpolymethylenepolyisocyanate (“multicore MDI”).

12. The process according to claim 1, wherein said polyether carbonate polyol (A) has blocks which correspond to formula (VIII) 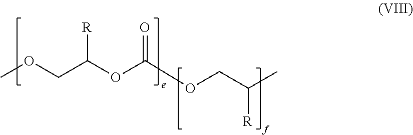
wherein the ratio of e:f is from 2:1 to 1:20.

13. A flexible polyurethane foam obtainable by a process according to claim 1.

14. The flexible polyurethane foam according to claim 13, wherein it is a hot-moulded foam.

15. An article comprising the flexible polyurethane foam according to claim 13 in furniture, textile inserts, bedding, automotive and/or construction industries.
